(19) United States
(12) Patent Application Publication
(10) Pub. No.: US 2011/0223101 A1
(43) Pub. Date: Sep. 15, 2011

(54) Combustion chamber hydrogen converter accelerator

(76) Inventors: William Timothy Williams, Warner Robins, GA (US); Caley Timothy Williams, Atlanta, GA (US)

(21) Appl. No.: 12/931,586

(22) Filed: Feb. 4, 2011

Related U.S. Application Data
(60) Provisional application No. 61/337,733, filed on Feb. 6, 2010.

(51) Int. Cl. C01B 3/04

(52) U.S. Cl. 423/658.2

(57) ABSTRACT

The present invention is directed to a hydrogen generating and regenerating system which supplies combustion gas and steam pressure from water to produce inexpensive energy. The system comprising of the process to supply hydrogen and oxygen over a porous metallic catalyst bed in a combustion chamber and igniting producing heat for boiler water to provide steam to turn a steam turbine. Then catalytically reforming steam over porous material producing hydrogen in a converter reactor zone and subsequently also producing combustion gas pressure in the combustion chamber that flow through the converter to turn a gas turbine, a compressor and a generator. The system passes a second catalytic promoter through the converter reactor zone to reactivate porous material by to produce additional hydrogen without using hydrogen generated. The gas combustion pressure passes through the turbine and heat exchangers preheating recycled water providing optimum efficiency and creating clean cheap electrons.

### CROSS-REFERENCE TO RELATED APPLICATIONS

This application is a continuation in-part of application No. 61/337,733, filed on Feb. 6, 2010, entitled Combustion Chamber Hydrogen Converter Accelerator.

This invention is an apparatus for generating hydrogen as a secondary clean energy source.

The apparatus can be best utilized with gas fueled turbine engines producing a minimum temperature of 500 degrees Celsius.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### BACKGROUND OF THE INVENTION

There is a growing interest to produce clean electric energy. Fossil fuels are exhaustible, increasingly expensive, and ecologically and climatically toxic. It is especially necessary to produce energy without using fossil fuels containing carbon that emit CO₂ and nitric acid, among other toxins. Approximately fifty percent of electrical power in the U.S. is produced by burning coal.

Currently, hydrogen gas is produced and consumed by the distillation and reformation of crude oil. In the U.S. about seventy five percent of all hydrogen is manufactured from natural gas which is mainly methane. The natural or refinery gases are treated by steam in the presence of a nickel catalyst. The gases react with the water vapor forming carbon monoxide and hydrogen.

Separation of hydrogen and carbon monoxide is accomplished by injecting the gas mixture with steam in the presence of a catalyst at high temperature by burning another fossil fuel. This step produces carbon dioxide and is then removed by absorption in a suitable aquatic solution containing a carbonate. The objective of this invention is to produce a clean non-polluting renewable energy that produces electric power efficiently.

In the iron and steel producing industry, the reduction of iron oxide in the form of iron ore to iron metal by using carbon in the form of coke, oxygen and hydrogen. Lime, alumina and silicone are added to form slag on top of the heated ore. The slag, oxide and impurities from the iron ore rise to the top and are removed. The iron absorbs two percent of carbon and other alloys producing steel.

Lime is produced from limestone and is widespread on the earth's Surface. Lime is term that includes both calcium oxide also called quicklime and calcium hydroxide, also called slacked lime. It is ranked sixth among industrial chemicals produced in the U.S. The largest consumer of lime is the steel industry. There is an exothermic reaction when water is added to lime. The reaction of quicklime with water is hot enough to cause combustible materials to ignite.

The present invention provides solution to the problem with current methods of producing hydrogen. The production hydrogen is expensive and gives off vast amounts pollution and heat from fossil fuels. An alternate means to produce hydrogen gas utilizes a method that separate hydrogen and oxygen by passing steam over a highly heated catalyst bed of reactive metals. The metal catalysts over use become deactivated. Hydrogen gas or hydrocarbons are used to regenerate catalyst using much of the equivalent hydrogen produced. Also producing pollutants by using hydrocarbons and nitrogen in the intake air at high temperatures.

The present invention provides a secondary stage that utilizes catalysts or promoters as oxidation reducers that regenerate the metallic catalysts efficiently without using hydrogen or hydrocarbons gas produced. The present invention is an apparatus that can be lined with limestone. As the primary catalyst and promoter plate become deactivated by a coating of oxide separated from the water vapor, a secondary catalyst containing calcium and alumina are introduced into the apparatus via a secondary line. The secondary catalysts reactivate the initial metallic catalyst and promoter plate. Then exits apparatus and is recycled through an aquatic carbonate solution releasing the calcium and alumina without using any of the hydrogen gas produced.

The present invention also provides a solution to allow a simple bolt on adaptation to present technologies that provide on demand electrical power generation at the point of need without the need for fossil fuels. The present invention utilizes a combustion chamber apparatus that allows flow through combustion pressure and heat energy to power gas and steam power generation technologies.

The present invention provides a solution of increased efficiency by the use of hydrogen and distilled oxygen as fuels ignited producing an exothermic reaction over an iron magnetite and alumina catalyst at a great heat of combustion, providing heat of formation to produce steam and heat to split hydrogen and oxygen from the water vapor. Also providing combustion pressure to turn a turbine. Splitting the water vapor in a second chamber over the catalyst bed and secondary regeneration reaction of the primary metal catalyst and recycling the secondary calcium catalyst produces an overall exothermic reaction.

The present invention provides another solution to increase efficiency by the use of a combined cycle that uses the additional heat generated above the temperature needed to separate the hydrogen to preheat condensed feed water to boiling point. By preheating feed water to steam conserves any other energy needed conserving latent heat of the apparatus. The availability to generate electric power at point of need conserves energy lost through long transmission lines.

The primary object of this invention is to provide a simple bolt on apparatus that can be easily adapted to current technologies producing hydrogen gas by burning hydrogen gas. Providing continuous renewable energy drawn from our environment enable us to recycle without depleting water supplies, that uses a refrigeration cycle to offset additional heat to environment, creating clean, cheap electrons.

### TECHNICAL FIELD OF THE INVENTION

This invention relates to an apparatus and a process to separate hydrogen and oxygen gases from water and to be used as produced. The process is suitable to allow chemical reactions in three stages. This invention is also suitable to be used in related systems which include the described process and apparatus.

### A BRIEF SUMMARY OF THE INVENTION

This invention is a process to produce hydrogen as a secondary clean source by supplying hydrogen and oxygen over a porous metallic catalyst bed in a combustion chamber and igniting producing heat for boiler water to provide steam to turn steam turbine and then catalytically reforming steam over porous material producing gas pressure to turn a gas turbine.

Passing a second catalytic promoter through the converter zone to reactivate porous material in the converter, when deactivated. The combustion gas pressure produced in the combustion chamber flows through the center of the converter into the gas turbine. The heated gas pressure then flows through the two heat exchangers preheating the feed water to boiling point. The gas turbine turns a fan producing compressed air for the distillation of oxygen and subsequently turns a generator.

The distilled oxygen and hydrogen fuels the combustion chamber without using atmospheric nitrogen removing the production of nitric acid at high temperatures. A solar collector receives solar energy, amplifies and focuses into converter providing additional heat energy to compensate for any heat loss due to resistance of the components. By supplying a second combustion chamber and converter continuously alternating hydrogen production and catalyst regeneration.

In sum, by utilizing the exothermic high heat of formation by the following: igniting hydrogen and oxygen inside a nickel alloy steel combustion chamber over an iron magnetite and alumina alloy producing heat energy well above temperatures needed to produce steam and separate hydrogen and oxygen from the steam; the formation of heat energy in the catalytic converter zone over the porous iron alloy catalyst and promoter plate;

the formation of heat over the catalyst bed and promoter plate in the converter catalytic zone of the regeneration step by introducing lime, calcium, magnesium and alumina reduces the oxide formed on the iron alloy. The sum of the heat energy released in these exothermic reactions is greater than the endothermic reaction of the separation of the hydrogen and oxygen from steam;
the formation of heat by recycling the calcium and oxide catalysts by-products through water containing bicarbonate.

### BRIEF DESCRIPTION OF THE SEVERAL VIEWS OF THE DRAWINGS

The accompanying drawings further describe the invention.

FIG. 1 is the combustion flame tube and hydrogen converter accelerator apparatus assembly view;

FIG. 2 is a separate view of the hydrogen catalytic converter, regenerator apparatus;

FIG. 3 is a cutaway view of FIG. 1;

FIG. 4 is a schematic flow process diagram of a dual steam and hydrogen producing gas turbine power generator integrated with heat recovery systems including, an amplified solar collector and two heat exchangers.

### DETAILED DESCRIPTION OF THE INVENTION

The apparatus consists of a converter constructed of a steel alloy cylinder tube of double wall construction with 10 mm diameter or greater rifled tube holes. Steel alloy channels circle interior wall of the converter hold the catalyst. The converter cylinder can be lined with limestone. The apparatus also contains a combustion chamber. The combustion chamber is a cylinder shaped flame tube also constructed of high temperature, high strength double wall steel alloy. The chamber is constructed to allow for an air intake port, gas nozzles and igniters would be fitted at the opposite end of the apparatus. A boiler lining surrounds the combustion area.

The preferred embodiment of the hydrogen converter utilizes a gas turbine engine, as its primary energy source. In a gas turbine engine compressed air is heated by burning fuel in the combustion area of the apparatus to produce a high-pressure high velocity gas. Energy is extracted from the flow of the high velocity gas to drive turbine. Heat is also extracted to heat a boiler and converter. The converter flame tube holes receive flames generated by burning fuel from the combustion chamber. The combustion pressure flows through converter to a gas turbine heating the converter and catalyst. The saturated steam is fed into the converter circulating over the heated catalyst source producing hydrogen gas.

The catalyst promoter plate contains approximately three percent oxides of potassium and aluminum. The converter tube is filled with pellets. The preferred shape of the pellets are cylinder in shape and can be round, oval, disc or granular. The preferred catalyst is predominately porous iron, a small percentage of cobalt and zinc, can consist of other metals that react with steam to produce hydrogen such as aluminum, chromium, magnesium, manganese and iron containing small amount of carbon. The combustion chamber apparatus contains holes for two nozzles that can be fitted to each side of the converter. One nozzle is to supply steam from the boiler to generate hydrogen. The other to supply an additional catalyst to regenerate the iron alloy that is converted to iron alloy oxide during the hydrogen production. The preferred catalysts to regenerate the catalyst material are calcium oxide, aluminum oxide and magnesium oxide.

The converter and combustion chamber apparatus preferred steel alloy consists of nickel and can contain other high temperature alloys of steel, such as chromium, cobalt, molybdenum, palladium or platinum. The invention is best utilized in a combined cycle with an additional boiler, converter apparatus and two heat exchangers can be placed in the exhaust gas flow to produce additional steam and hydrogen. The two heat exchangers enable the feed water to be preheated to boiling point, retaining latent heat and reducing the amount of energy needed to produce steam for power and hydrogen production. A single parabolic disc shaped solar collectors focus additional heat externally to the converters, completing an inexpensive efficient clean energy combined cycle. The gas turbine produces high velocity gas to turn turbines, fans and a generator to provide electrical power generation.

The preferred embodiment of this invention solves the problem of using hydrogen or hydrocarbons to regenerate catalyst in the converter zone. The overall heat of formation in the combustion, regeneration step and the recycling of the oxide material is greater than the heat energy needed to separate the hydrogen from the water vapor in the converter reactor zone. The preferred embodiment of the converter apparatus allow the combustion chamber heated gas pressure to flow through the converter and simultaneously heat a boiler for steam and pressure to turn a steam turbine and a gas turbine.

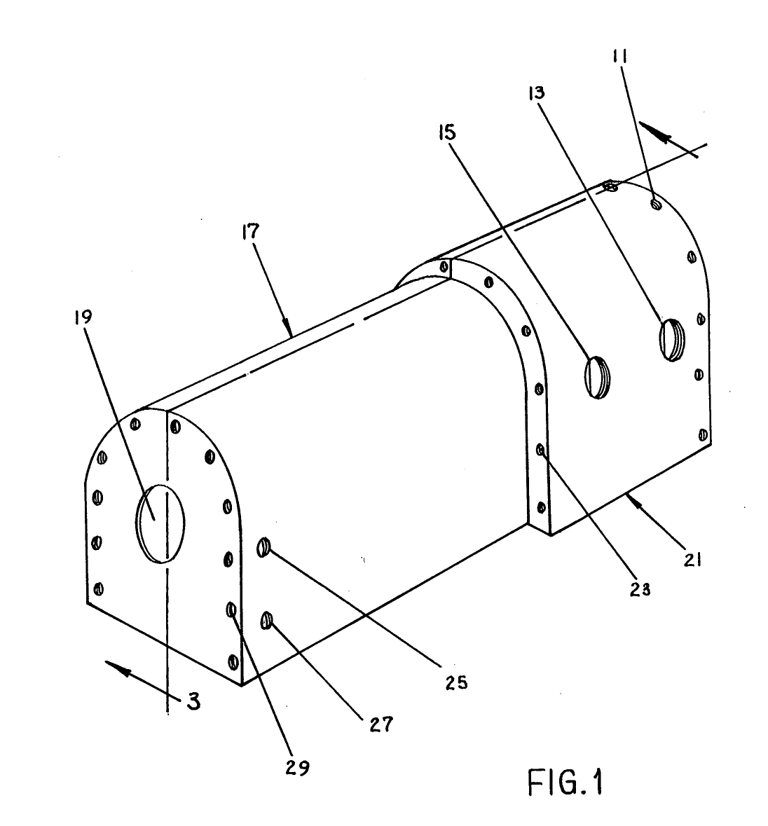

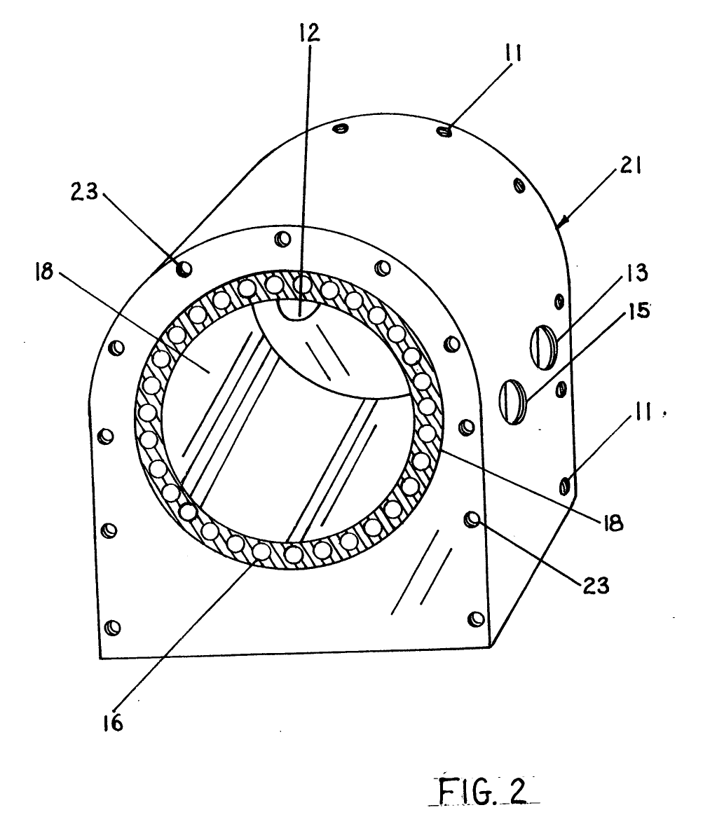

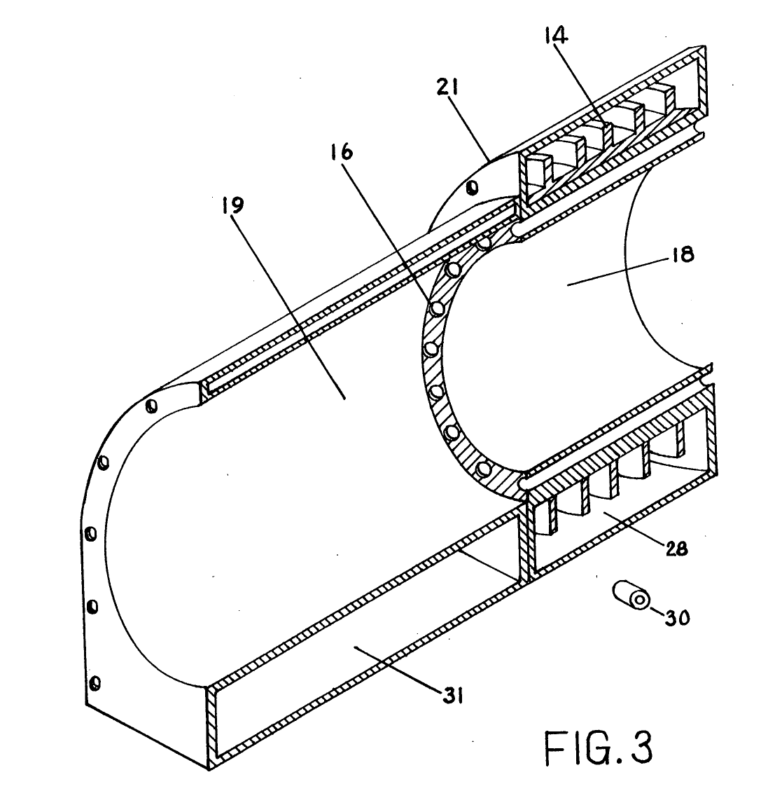

In FIG. 1, an incoming air stream preferably oxygen is received into the combustion chamber flame tube hole intake 19, gas preferably hydrogen is injected through port, 27, mixed and ignited by an igniter through port 25. The ignited gases form heat and combustion pressure. The rifled flame tubes holes in the steel alloy converter cylinder receive the heated combustion pressure FIG. 2, 16 from the combustion chamber flame tube FIG. 1, 19 heating the catalyst FIG. 3, 30 and promoter plate FIG. 3, 28 in the converter chamber FIG. 2, 21, heated combustion pressure also exits the converter chamber tubes FIG. 2, 16 and heat the boiler FIG. 3, 31. Additional exhaust gases containing heat energy flow through converter chamber tube FIG. 2, 18 to secondary converter chamber FIG. 2, 21 showing the right side of the apparatus and the left side mirrors the right side.

The heat generated by the combustion gases ignited the combustion chamber FIG. 3, 19 heats the adjacent boiler reservoir FIG. 3, 31 creating high-pressure steam that flows into catalyst converter chamber the heated over catalyst bed pellets FIG. 3, 30 through opening FIG. 2, 15. The hydrogen gas separates from the oxygen gas, the oxygen adheres to the catalyst. The hydrogen gas exits out the opposite side of the converter FIG. 2, 15.

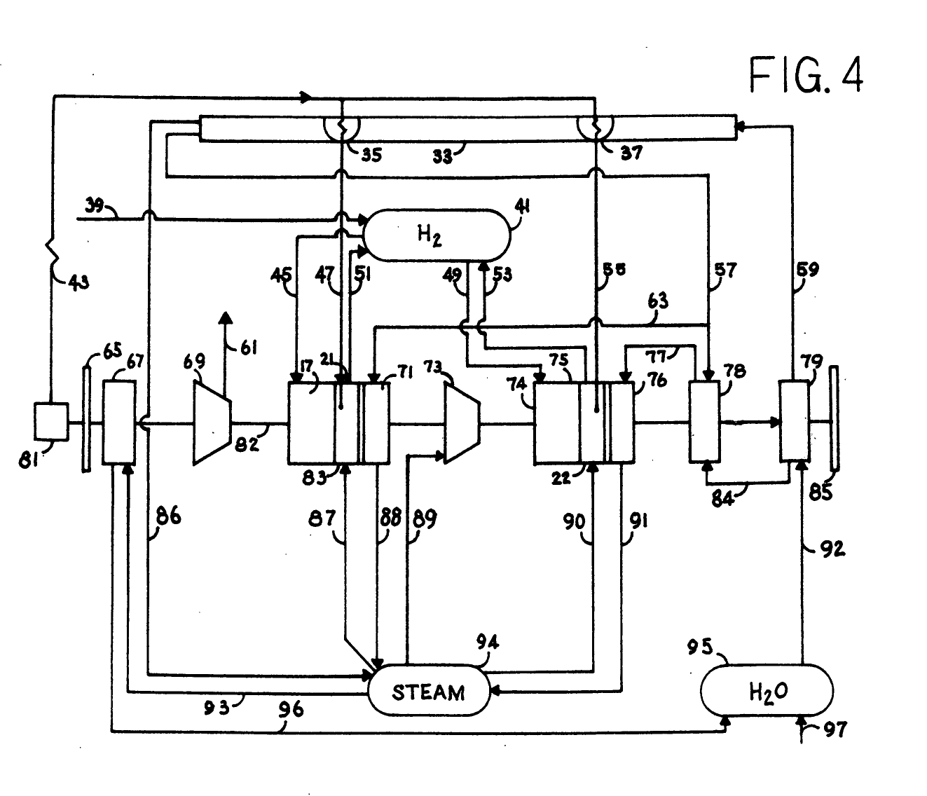

The aforementioned combustion chamber hydrogen converter optimum efficiency is obtained by utilizing a combined cycle as shown in FIG. 4 flow chart. When air is pulled in via an oversized fan 65 into the turbine compressor 69. A portion of the air is circulated to an oxygen distillation column 61. Gas, preferably hydrogen is also injected via line 45 and 49. The mixture is then ignited and burned heating water in the boilers 71 and 76 creating high pressure steam that feed the hydrogen converters 21 and 22 via lines 51 and 53 to the hydrogen tank 41. The initial exhaust gases produced in the combustion chamber 17 expands, flow through converter 83 and power the gas turbine main shaft, fans 65 and 85 and generator 81 via line 82. As catalyst becomes coated with oxide a secondary catalyst is injected into aforementioned converter 83 regenerating the iron alloy catalyst. The hydrogen 41 and steam production 94 via lines 93 and 96 and catalyst regeneration process is repeated as the exhaust stream and heat flow through a second converter 74 also heating boiler 76 producing steam via line 91 additional heat is extracted through heat exchangers 78 and 79 preheating feed water 97 via line 92 conserving the majority of latent heat of total combined cycle. Additional overall efficiency can be realized by amplifying electrical current via line 43 produced in a parabolic solar collector 35. An amplified solar energy apparatus 33 and 37 can then be directed to the converter via lines 47 and 55.

What is claimed:

1. In an energy system, the process of producing hydrogen comprising:
supplying hydrogen and oxygen over a porous metallic catalyst bed in a combustion chamber and igniting producing heat for boiler water to provide steam to turn a steam turbine and then catalytically reforming steam over heated porous material producing hydrogen in converter reactor zone and subsequently producing combustion gas pressure to turn a gas turbine;
passing a second catalytic promoter through the said converter reactor zone to reactivate porous material;
discharging said combustion pressure through gas turbine through two heat exchangers preheating feed water to boiling point;
gas turbine turns fan producing compressed air for distillation column and subsequently turns generator;
collecting and amplifying solar energy focusing onto converter reactor;
supplying a secondary said combustion chamber and said converter reactor in combustion pressure flow provide alternating hydrogen production and catalyst regeneration zones providing additional efficiency.

2. The process of claim 1 further comprising the step of combusting said hydrogen and said oxygen over the preferred catalyst bed of iron magnetite and alumina to aid in heating, increasing exothermic heat of formation.

3. The process of claim 1 further comprising steps of;
heating said boiler and said converter tubes that surround said combustion chamber by said combustion gas that also flows through the gas turbine;
heating said porous catalyst material in said converter comprising of a high temperature steel alloy tube surrounding the combustion chamber tube which is attached and enclosed by circular plates with center holes sized to said combustion chamber outside diameter, the said converter is attached by a promoter plate consisting of a steel alloy consisting of small percents of aluminum and potassium oxide, the said converter is also lined with limestone.

4. The process of producing hydrogen according to claim 1 wherein passing a said second catalytic promoter containing lime, calcium and manganese through said reactor zone producing another exothermic oxidation reduction reaction regenerating the said porous metallic catalyst bed without using previously produced said hydrogen.

5. The process of producing hydrogen according to claim 3 wherein said heating of said converter promoter plate reduces the temperature necessary to separate the said hydrogen from the said steam water vapor and disassociated oxygen.
